(19) United States
(12) Patent Application Publication
(10) Pub. No.: US 2016/0023517 A1
(43) Pub. Date: Jan. 28, 2016

(54) REDUCED WEIGHT AIRCRAFT TIRE

(71) Applicant: The Goodyear Tire & Rubber Company, Akron, OH (US)

(72) Inventors: Frank Anthony Kmiecik, Akron, OH (US); Leonard James Reiter, Norton, OH (US)

(21) Appl. No.: 14/745,625

(22) Filed: Jun. 22, 2015

Related U.S. Application Data
(60) Provisional application No. 62/027,278, filed on Jul. 22, 2014.

(51) Int. Cl. B60C 9/20; B60C 9/00

(52) U.S. Cl. CPC B60C 9/2009; B60C 9/0042; B60C 9/005; B60C 2009/2016; B60C 2009/2029

(57) ABSTRACT

A pneumatic tire having a carcass and a belt reinforcing structure, the belt reinforcing structure comprising: a zigzag belt reinforcing structure formed of a strip of reinforcement cords, the strip of reinforcement cords being inclined at 5 to 30 degrees relative to the centerplane of the tire extending in alternation to turnaround points at each lateral edge, wherein the strip of cords is formed from two different cords made of different materials.

### FIELD OF THE INVENTION

This invention relates to pneumatic tires having a carcass and a belt reinforcing structure, more particularly to high speed heavy load tires such as those used on aircraft.

### BACKGROUND OF THE INVENTION

Pneumatic tires for high speed applications experience a high degree of flexure in the crown area of the tire as the tire enters and leaves the area of the footprint. This problem is particularly exacerbated on aircraft tires wherein the tires can reach speed of over 200 mph at takeoff and landing.

When a tire spins at very high speeds the crown area tends to grow in dimension due to the high angular accelerations and velocity, tending to pull the tread area radially outwardly. Counteracting these forces is the load of the vehicle which is only supported in the small area of the tire known as the footprint area.

Current tire design drivers are an aircraft tire capable of high speed, high load and with reduced weight. It is known in the prior art to use zigzag belt layers in aircraft tires, such as disclosed in the Watanabe U.S. Pat. No. 5,427,167. Zigzag belt layers have the advantage of eliminating cut belt edges at the outer lateral edge of the belt package. The inherent flexibility of the zigzag belt layers also help improve cornering forces. However, a tire designed with zigzag belt layers may result in too many layers at the belt edges which may reduce durability. Further, there is generally a tradeoff between load capacity and weight. Thus an improved aircraft tire is needed, which is capable of meeting high speed, high load and with reduced weight.

### Definitions

“Carcass” means the tire structure apart from the belt structure, tread, undertread, and sidewall rubber over the plies, but including the beads.

“Circumferential” means lines or directions extending along the perimeter of the surface of the annular tread perpendicular to the axial direction.

“Cord” means one of the reinforcement strands of which the plies in the tire are comprised.

“Equatorial plane (EP)” means the plane perpendicular to the tire's axis of rotation and passing through the center of its tread.

“Ply” means a continuous layer of rubber-coated parallel cords.

“Radial” and “radially” mean directions radially toward or away from the axis of rotation of the tire.

“Radial-ply tire” means a belted or circumferentially-restricted pneumatic tire in which the ply cords which extend from bead to bead are laid at cord angles between 65° and 90° with respect to the equatorial plane of the tire.

“Section width” is the distance between a tire's sidewalls measured at the widest part of the tire when inflated to rated pressure and not under load.

“Zigzag belt reinforcing structure” means at least two layers of cords or a ribbon of parallel cords having 1 to 20 cords in each ribbon and laid up in an alternating pattern extending at an angle between 5° and 30° between lateral edges of the belt layers.

### BRIEF DESCRIPTION OF THE DRAWINGS

FIG. 1 is a schematic cross-sectional view of a first embodiment of half of a tire according to the invention;

FIG. 2 is a schematic perspective view of a zigzag belt layer in the middle of the formation;

FIG. 3 is a schematically enlarged cross-sectional view of a first embodiment of half of a composite belt package for a tire showing the belt layer configuration;

FIG. 4 is a schematically enlarged cross-sectional view of a second embodiment of a composite belt package showing the belt layer configuration;

FIG. 5 is a cross-sectional view of a composite strip of the present invention.

### DETAILED DESCRIPTION OF THE INVENTION

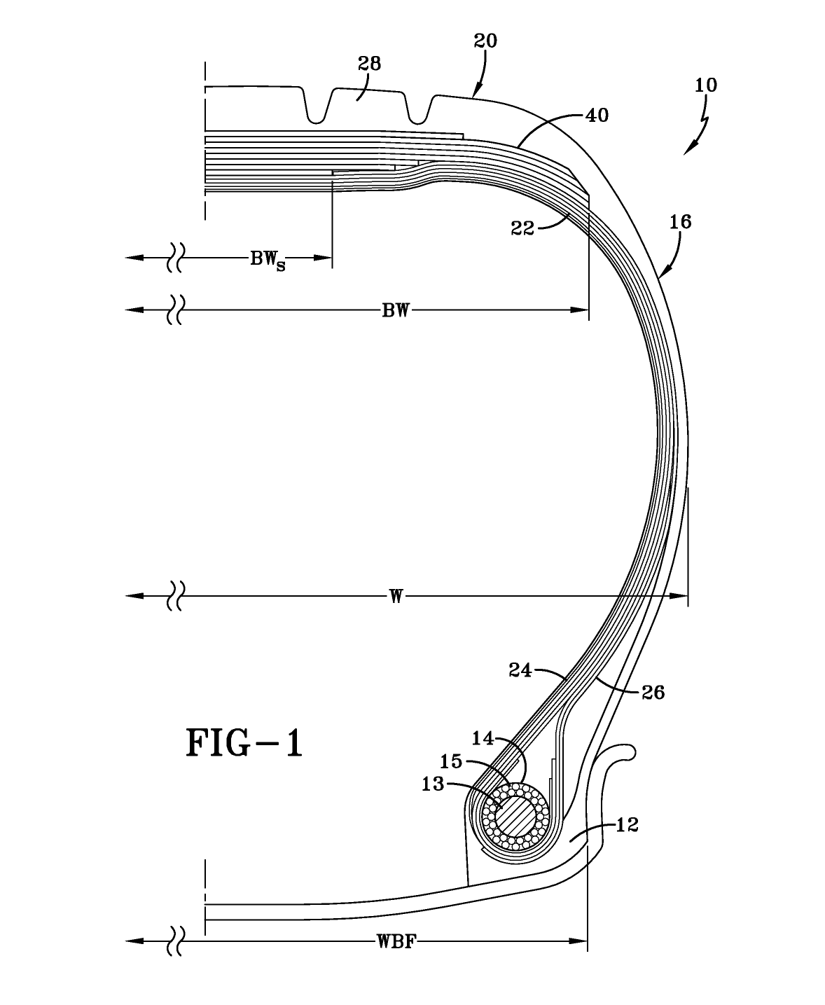

FIG. 1 illustrates a cross-sectional view of one half of a radial aircraft tire 10 of the present invention. The tire is symmetrical about the mid-circumferential plane so that only one half is illustrated. As shown, the aircraft tire comprises a pair of bead portions 12 each containing a bead core 14 embedded therein. One example of a bead core suitable for use in an aircraft tire is shown in U.S. Pat. No. 6,571,847. The bead core 14 preferably has an aluminum, aluminum alloy or other light weight alloy in the center portion 13 surrounded by a plurality of steel sheath wires 15. A person skilled in the art may appreciate that other bead cores may also be utilized.

The aircraft tire further comprises a sidewall portion 16 extending substantially outward from each of the bead portions 12 in the radial direction of the tire, and a tread portion 20 extending between the radially outer ends of the sidewall portions 16. The tire is shown mounted on a rim flange having a rim flange width extending from one bead to the other bead and indicated as W_{BF} in FIG. 1. The section width of the tire is indicated in FIG. 1 as W and is the cross-sectional width of the tire at the widest part when inflated to normal pressure and not under load.

Furthermore, the tire 10 is reinforced with a carcass 22 toroidally extending from one of the bead portions 12 to the other bead portion 12. The carcass 22 is comprised of inner carcass plies 24 and outer carcass plies 26, preferably oriented in the radial direction. Among these carcass plies, typically four inner plies 24 are wound around the bead core 14 from inside of the tire toward outside thereof to form turnup portions, while typically two outer plies 26 are extended downward to the bead core 14 along the outside of the turnup portion of the inner carcass ply 24.

The aircraft may preferably be an H type tire having a ratio of W_{BF}/W in the range of about 0.65 to 0.7, and more preferably in the range of about 0.65 to about 0.68.

Each of these carcass plies 24,26 may comprise any suitable cord, typically nylon cords such as nylon-6,6 cords extending substantially perpendicular to an equatorial plane EP of the tire (i.e. extending in the radial direction of the tire). Preferably the nylon cords have an 1890 denier/2/2 or 1890 denier/3 construction. One or more of the carcass plies 24, 26 may also comprise an aramid and nylon cord structure, for example, a hybrid cord, a high energy cord or a merged cord. Examples of suitable cords are described in U.S. Pat. No. 4,893,665, U.S. Pat. No. 4,155,394 or U.S. Pat. No. 6,799,618. The ply cords may have a percent elongation at break greater than 8% and less than 30%, and more preferably greater than 9% and less than 28%.

The aircraft tire 10 further comprises a belt package 40 arranged between the carcass 22 and the tread rubber 28. FIG. 3 illustrates a first embodiment of one half of a belt package 40 suitable for use in the aircraft tire. The belt package 40 is symmetrical about the mid-circumferential plane so that only one half of the belt package is illustrated. The belt package 40 as shown comprises a first belt layer 50 located adjacent the carcass. The first belt layer 50 is preferably formed of reinforcement cords forming an angle of 10 degrees or less with respect to the mid-circumferential plane, and more preferably, 5 degrees or less. Preferably, the first belt layer 50 is formed of a rubberized strip 41 of two or more cords made by spirally or helically winding the cords relative to the circumferential direction. The first belt layer 50 is the narrowest belt structure of the belt package 40, and has a width in the range of about 13% to about 100% of the rim width (width between flanges).

The belt package 40 further comprises a second belt layer 55 located radially outward of the first belt layer 50. The second belt layer 55 is preferably formed of cords having an angle of 10 degrees or less with respect to the mid-circumferential plane. Preferably, the second belt layer 55 is formed of a rubberized strip 41 of two or more cords made by spirally or helically winding the cords relative to the circumferential direction. The second belt layer has a width in the range of about 13% to about 100% of the rim width. Preferably the second belt layer 55 has a width the same or slightly greater than the first belt layer 50. The belt package 40 may further comprise a third belt layer 60 and a fourth belt layer 61. The third belt layer 60 is located radially outward of the second belt layer 55, and may be substantially wider than the second belt layer. The fourth belt layer is located radially outward of the third belt layer 60, and may be the same width as the third belt layer 60 or slightly wider. The third and fourth belt layers 60,61 are low angle belts, typically with a belt angle of 10 degrees or less with respect to the mid-circumferential plane. Preferably, the third and fourth belt layers 60, 61 are formed of a rubberized strip 41 of two or more cords made by spirally or helically winding the cords relative to the circumferential direction.

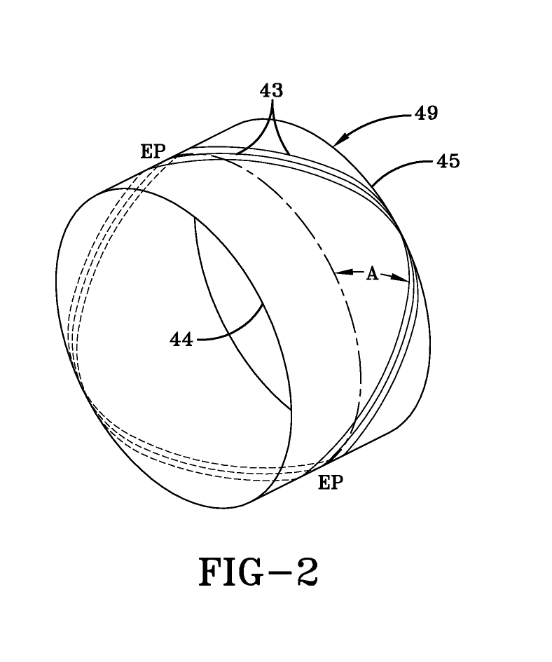

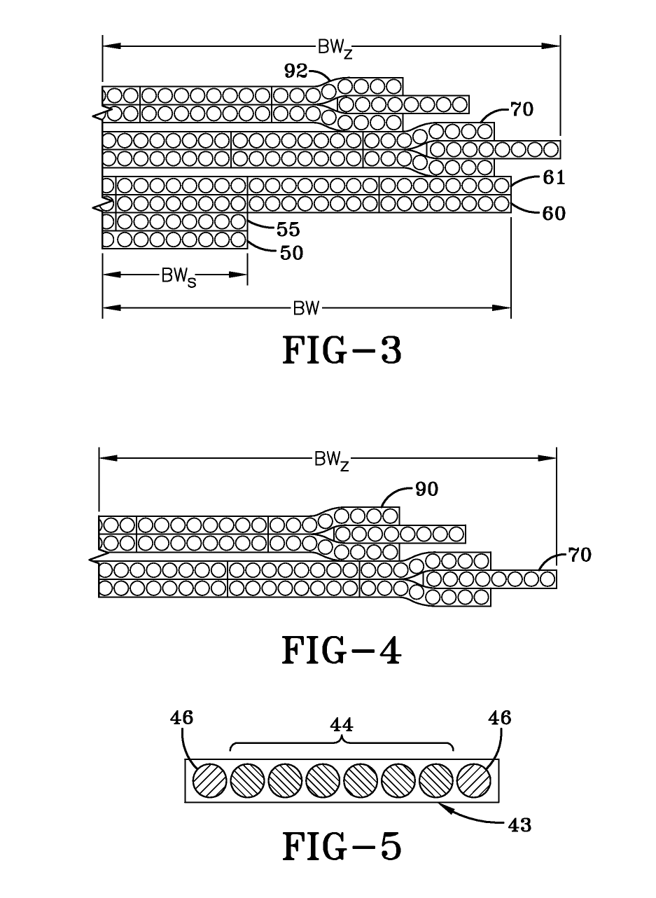

The belt package 40 further comprises at least one zigzag belt reinforcing structure 70. The zigzag belt reinforcing structure 70 is comprised of two layers of cord interwoven together formed as shown in FIG. 2. The zigzag belt structure is formed from a rubberized composite strip 43 of two or more cords. The composite strip 43 is shown in FIG. 5 and described in more detail, below. The composite strip 43 is wound generally in the circumferential direction to extend between alternating lateral edges 44 and 45 of a tire building drum 49 or core. The strip is wound along such zigzag path many times while the strip 43 is shifted a desired amount in the circumferential direction so as not to form a gap between the adjoining strips 43. As a result, the cords extend in the circumferential direction while changing the bending direction at a turnaround point at both ends 44, 45. The cords of the zigzag belt structure cross with each other, typically at a cord angle A of 5 degrees to 30 degrees with respect to the equatorial plane EP of the tire when the strip 43 is reciprocated at least once between both side ends 44 and 45 of the ply within every 360 degrees of the circumference as mentioned above. The two layers of cords formed in each zigzag belt structure are embedded and inseparable in the belt layer and wherein there are no cut ends at the outer lateral ends of the belt.

In order to reduce the number of overlapping strips at the belt edges, it is preferred that the amplitude or width of the zigzag belt winding be varied. Generally, a zigzag belt is formed to have a constant amplitude or width. In order to reduce the number of layers at the belt edges, the amplitude (distance from the drum center to the axial end of the drum) of the zigzag can be varied. The amplitude can be varied randomly, or it can be carried by a pattern. In one example, a first zigzag winding on the drum has a first winding pattern of W1W2, wherein W1 is a first amplitude, and W2 is a second amplitude which immediately follows the first amplitude, wherein W1 is not equal to W2. A second winding is overlayed on the first winding, and has a second winding pattern of W2W1. Each winding pattern is repeated as often as necessary to complete the winding on the drum.

The composite strip 43 is shown in FIG. 5, may be used to form any of the above described belt structures, and is preferably used to form at least one of the zigzag belt structures. More preferably, the composite strip is used to form all of the zigzag belt structures. The composite strip 43 is formed of at least two types of reinforcement cords 44,46. The first cord reinforcement 44 has a higher modulus than the second cord reinforcement 46. Preferably, the composite strip has at least two higher modulus reinforcement cords 44 located laterally inward on the strip, and at least two lower modulus reinforcement cords. The lower modulus reinforcement cords 46 are located on the lateral outer ends of the composite strip. FIG. 5 illustrates a cross-sectional view of an exemplary composite strip. In this example, there are 8 total reinforcement cords arranged in parallel relationship to each other. The composite strip 43 has a lower modulus cord reinforcement 46 located on each lateral edge of the strip. There could also be four outer reinforcement cords 46, with two reinforcement cords 46 located at each lateral edge. The composite strip 43 as shown in FIG. 5 has six higher modulus reinforcement cords 44 located laterally inward of the lower modulus reinforcement cords 46. The lower modulus reinforcement cords 46 may be formed of any desired materials, such as nylon or nylon 6,6. The inner reinforcement cords 44 may be formed of any higher modulus material such as aramid, POK or a merged or hybrid cord made of aramid and nylon. One example of a suitable cord construction may comprise a composite of aramid and nylon, containing two cords of a polyamide (aramid) with construction of 3300 dtex with a 6.7 twist, and one nylon or nylon 6/6 cord having a construction of 1880 dtex, with a 4.5 twist. The overall merged cable twist is 6.7. Preferably, the belt cords have an elongation at break greater than about 8% and less than about 26% and break strength greater than about 400N. More preferably, the belt cords have an elongation at break in the range of about 9% to about 25%.

FIG. 4 illustrates a second embodiment of the present invention. The second embodiment includes a first and second zigzag belt structure 80, 90. The second zigzag belt structure 90 is located radially outward of the first zigzag belt structure 80. The second zigzag belt structure 90 has a width less than the first zigzag belt structure 80.

It is additionally preferred that the ply cords have a greater elongation at break than the belt cords elongation at break. The cord properties such as percent elongation at break, linear density and tensile strength are determined from cord samples taken after being dipped but prior to vulcanization of the tire.

Variations of the present invention are possible in light of the description as provided herein. While certain representative embodiments and details have been shown for the purpose of illustrating the subject inventions, it will be apparent to those skilled in the art that various changes and modifications can be made without departing from the scope of the subject inventions.

What is claimed is:

1. A pneumatic tire having a carcass and a belt reinforcing structure, the belt reinforcing structure comprising:
a zigzag belt reinforcing structure formed of a reinforcement strip comprised of at least two reinforcement cords, the reinforcement strip of reinforcement cords being inclined at 5 to 30 degrees relative to the centerplane of the tire extending in alternation to turnaround points at each lateral edge, wherein the strip of cords is formed a first cord and a second cord, wherein the first cord and the second cord are made of different materials.

2. A pneumatic tire having a carcass and a belt reinforcing structure, the belt reinforcing structure comprising a reinforcement strip comprised of at least three reinforcement cords aligned in parallel relationship, wherein the second cord is located between the first cord and the second cord, wherein the second cord is made of a different material than the first cord and the third cord.

3. The pneumatic tire of claim 2 wherein the first cord and the third cord are each made of nylon.

4. The pneumatic tire of claim 2 wherein the second cord is made of aramid.

5. The pneumatic tire of claim 2 wherein the second cord is made of a blend of aramid and nylon.

6. The pneumatic tire of claim 2 wherein the second cord is made of merged cord.

7. The pneumatic tire of claim 2 wherein the reinforcement strip is wound in a zigzag manner to form a zigzag belt.

8. A pneumatic tire having a carcass and a belt reinforcing structure, the belt reinforcing structure comprising a reinforcement strip comprised of at least 6 inner reinforcement cords and two outer cords aligned in parallel relationship, wherein the outer cords at the lateral ends of the strip are made of a different material than the inner cords.

9. The pneumatic tire of claim 8 wherein the outer cords are made of nylon.

10. The pneumatic tire of claim 8 wherein the inner cords are made of aramid.

11. The pneumatic tire of claim 8 wherein the inner cords is made of a blend of aramid and nylon.

12. The pneumatic tire of claim 8 wherein the inner cords are made of a higher modulus at 80% load than the inner cord at 80% load.

13. The pneumatic tire of claim 8 wherein the reinforcement strip is wound in a zigzag manner to form a zigzag belt.

14. A pneumatic tire having a carcass and a belt reinforcing structure, the belt reinforcing structure comprising:
a zigzag belt reinforcing structure being formed of two layers of a reinforcement strip having a first and second reinforcement cord, said reinforcement strip being inclined at 5 to 30 degrees relative to the centerplane of the tire extending in alternation to turnaround points at each lateral edge, wherein the first reinforcement cord has a different modulus than the second reinforcement cord.
